(19) United States
(12) Patent Application Publication
(10) Pub. No.: US 2020/0078267 A1
(43) Pub. Date: Mar. 12, 2020

(54) Method for Heat Source Acupuncture and Body Shaping

(71) Applicant: Farrah Haley, Murfreesboro, TN (US)

(72) Inventor: Farrah Haley, Murfreesboro, TN (US)

(21) Appl. No.: 16/509,692

(22) Filed: Jul. 12, 2019

Related U.S. Application Data
(60) Provisional application No. 62/727,594, filed on Sep. 6, 2018.

(51) Int. Cl. A61H 39/08; A61H 39/02

(52) U.S. Cl. CPC A61H 39/086; A61H 39/04; A61H 39/02

(57) ABSTRACT

A method for heat source acupuncture and body shaping. The method for heat source acupuncture includes the steps of inserting a plurality of needles various tissue locations. The tissue locations are of various depths and locations. The method further includes having at least three needles placed into the tissue at 45-degree angles. The needles are inserted at various depths between a quarter inch to 5 inches of tissue Once the needles are inserted into the tissue, the ends not in the tissue are heated. The needles are heated for 3 seconds each. The process of heating is repeated for each needle 30 times or until sweating is induced.

### CROSS REFERENCE TO RELATED APPLICATIONS

This application claims the benefit of U.S. Provisional Application No. 62/727,594 filed on Sep. 6, 2018. The above identified patent application is herein incorporated by reference in its entirety to provide continuity of disclosure

### BACKGROUND OF THE INVENTION

The present invention relates to a method for heat source acupuncture and body shaping. More particularly, the present invention provides a method for heat source acupuncture and body shaping that includes placing a plurality of needles into tissue then heating the needles to induce sweating.

Many people have tried all manner of body shaping techniques. Traditionally a strict diet and forms of exercise are good starting points. However, they do not always do the trick. Often many people turn to methods of inducing sweat such as saunas or steam rooms. This can become expensive after a while. Using a sauna or steam room can mean purchasing a gym membership. This can cost in upwards of 50 dollars a month. Further, if a gym membership is unwanted an individual can have a personal sauna or steam room built. This can be even more costly.

Further, many people have turned to the ancient art of acupuncture for various ailments and issues. Many times, this ancient art has great success. The art of acupuncture uses needles placed at specific depths and at specific points on the body. There are hundreds of these points located on the body and each of them has a different result. By placing the needles at different angles and different depths different results can be achieved.

There is a trend today to innovate old ideas with new to create a better method for body shaping. People all over the world struggle with weight problems, especially in America. These new and innovative body shaping methods are becoming a necessary part of life in the attempt to make a healthier nation.

Consequently, there is a need in for an improvement in the art of acupuncture and body shaping. The present invention substantially diverges in design elements from the known art while at the same time solves a problem many people face when trying to lose weight using various different techniques. In this regard the present invention substantially fulfills these needs.

### SUMMARY OF THE INVENTION

The present invention provides a method for heat source acupuncture and body shaping wherein the same can be utilized for providing convenience for the user when using an acupuncture treatment for body shaping. The present method for heat source acupuncture and body shaping comprises inserting a plurality of needles into tissue. An end of each of the plurality of needles is then heated in turn. This process is repeated until sweat is induced.

Another object of the invention is the method for heat source acupuncture and body shaping, wherein the plurality of needles is at least three needles.

Another object of the invention is the method for heat source acupuncture and body shaping, further comprising inserting a first needle into 2 inches or 3 inches of tissue, wherein the needle is placed 1 inch deep.

Another object of the invention is the method for heat source acupuncture and body shaping, wherein the first needle is placed at a 45-degree angle relative to the surface of the skin.

Another object of the invention is the method for heat source acupuncture and body shaping, further comprising inserting a second needle into 3 inches to 5 inches of tissue, wherein the needle is placed 1.5 inches deep.

Another object of the invention is the method for heat source acupuncture and body shaping, wherein the second needle is placed at a 45-degree angle.

Another object of the invention is the method for heat source acupuncture and body shaping, further comprising inserting a third needle into a minimal amount of tissue, wherein the needle is placed 0.25 inches deep.

Another object of the invention is the method for heat source acupuncture and body shaping, wherein the first needle is placed at a 45-degree angle relative to the surface of the skin.

Another object of the invention is the method for heat source acupuncture and body shaping, further comprising heating each of the plurality of needles for at least 3 seconds.

Another object of the invention is the method for heat source acupuncture and body shaping, wherein each needle is heated 30 times.

Another object of the invention is the method for heat source acupuncture and body shaping, wherein the heat source is an open flame.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flow chart of an embodiment of the method for heat source acupuncture and body shaping.

FIG. 2 shows a perspective view of an embodiment of three needles inserted into tissue at specific depths.

FIG. 3 shows a perspective view of an embodiment of three needles inserted into tissue at 45-degree angles.

FIG. 4 shows a perspective view of an embodiment of the needles being heated.

### DETAILED DESCRIPTION OF THE INVENTION

Reference is made herein to the attached drawings. Like reference numerals are used throughout the drawings to depict like or similar elements of the method for heat source acupuncture and body shaping. For the purposes of presenting a brief and clear description of the present invention, a preferred embodiment will be discussed as used for the method for heat sourcing acupuncture and body shaping. The figures are intended for representative purposes only and should not be considered to be limiting in any respect.

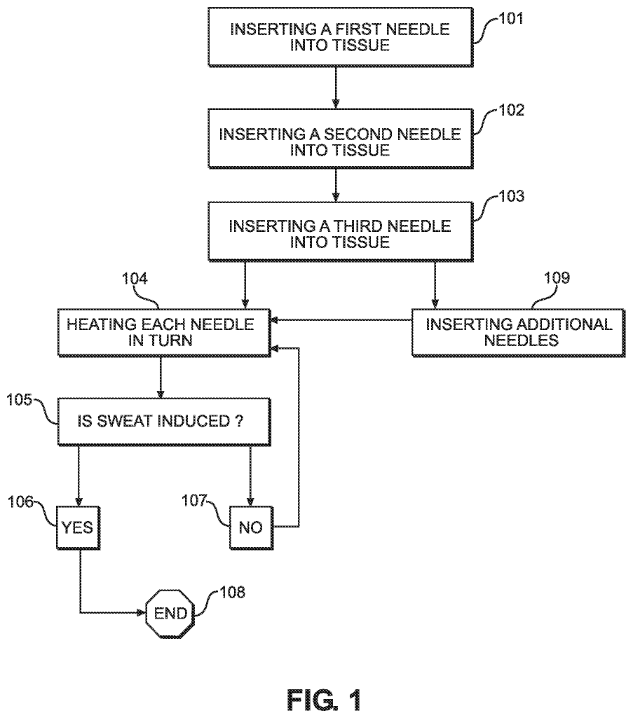

Referring now to FIG. 1, there is shown a flow chart of an embodiment of the method for heat source acupuncture and body shaping. The method for heat source acupuncture and body shaping includes inserting a plurality of needles into a desired location then heating the needles. The plurality of needles should be acupuncture needles. In one embodiment, the plurality of needles is entirely made from surgical steel. The plurality of needles can be made in various thicknesses depending on the desired result. The method for heat source acupuncture and body shaping begins by inserting a first needle into desired tissue 101. The first needle should be an acupuncture needle. In one embodiment, the needle is entirely made from surgical steel. The first needle can be made in various thicknesses depending on the desired result. Next, a second needle is inserted into desired tissue 102. A third needle is then inserted into desired tissue 103. From this point additional needles may be placed in desired tissue 109.

Once all of the desired needles are placed in the tissue each needle shall be heated in turn 104. In one embodiment, each needle is heated for 30 seconds. In this embodiment, each needle is heated 6 to 10 times. In a second embodiment, each needle is heated for 3 seconds. In this embodiment, each needle is heated 30 to 45 times. The heating process is determined in the following manner. Once the needles are heated, the acupuncturist will look to determine if sweat is induced 105. If no sweat is induced 107, then the needles will be heated for another round 104. This process of heating the needles 104 and determining if sweat is induced 105 will continue until sweat is induced 106. Once sweat is induced, the method for heat source acupuncture and body shaping comes to an end. One of ordinary skill in the art will understand that the needles will then have to removed and properly disposed of.

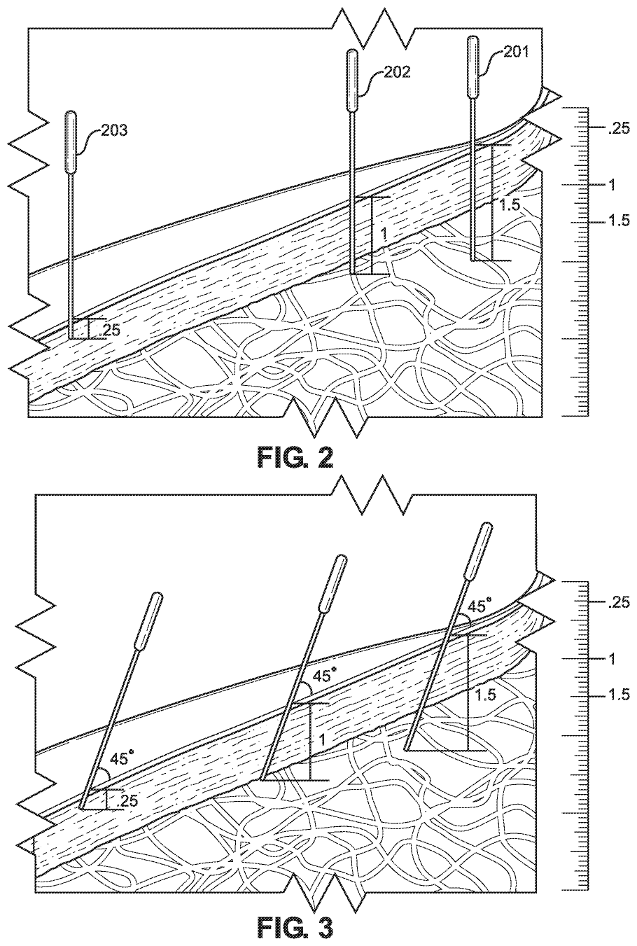

Referring now to FIG. 2, there is shown a perspective view of an embodiment of three needles inserted into tissue at specific depths. In one embodiment, the needles should be placed to approximate depths to provide the greatest results. In an embodiment, the first needle 201 should be placed to a depth of 1.5 inches. In one embodiment, the first needle 201 should be placed to two inches. In an embodiment, the second needle 202 should be placed in at a depth of one inch. In another embodiment, the second needle 202 should be placed in at a range of a depth of 0.75 inches to a depth of 1.25 inches. In an embodiment, the third needle 203 should be placed in at a depth of 0.25 of an inch.

Referring now to FIG. 3, there is shown a perspective view of an embodiment of three needles inserted into tissue at 45-degree angles. In one embodiment, the needles shall be placed into the desired tissue at a 45-degree angle. At this angle, the needles shall still be placed in at the depths as described in FIG. 2. Being 1.5 inches 1 inch and 0.25 of an inch respectively. At this angle, using these depths the needles will be able to contact a greater amount of tissue. This is because the needle will take a more gradual path in reaching the desired depth. The greater area the needles come into contact with, the faster sweat can be induced. This is because the heat will be able to be better dispersed within the tissue.

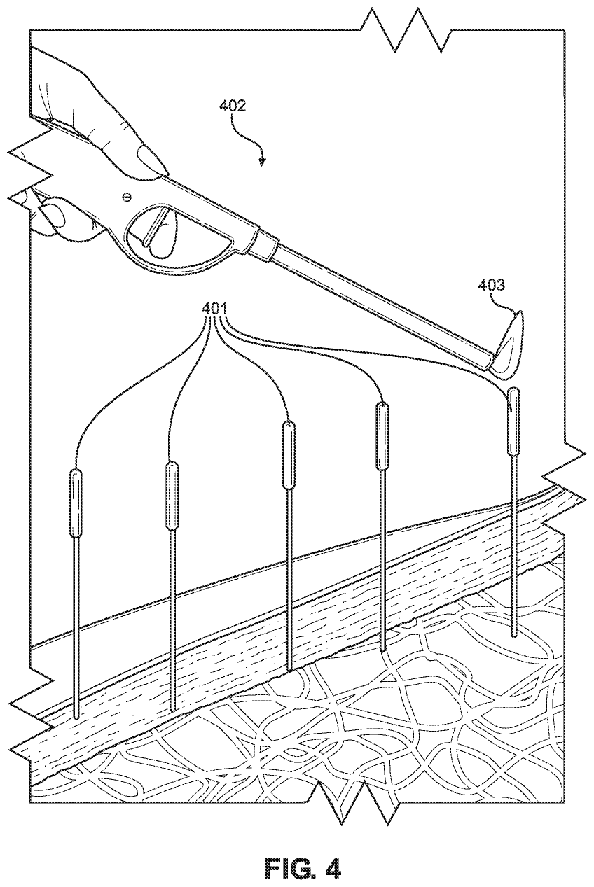

Referring now to FIG. 4, there is shown a perspective view of an embodiment of the needles being heated. In an embodiment, more than three needles are placed in the desired tissue. In the illustrated embodiment, there is a plurality of needles 401 disposed at various depths within the tissue of a user. While the drawing shows five needles, one of ordinary skill in the art will understand that many more needles 401 may be used to achieve desired effect. Further, FIG. 4 shows a heat source 402, for the method. In one embodiment, the heat source 402 is a lighter or other device that produces an open flame 403. In this embodiment, the heat source 402 will produce a flame 403 that is to be held over the ends of the needles 401 that are protruding from the desired tissue. In this embodiment, the heat source 402 will heat the needles 401 to cause the desired sweating effect to the selected area. In another embodiment, different heat sources 402 may be used such as an electric heating device.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for heat source acupuncture and body shaping, comprising:
inserting a plurality of needles into tissue;
heating an end of each of the plurality of needles in turn;
repeatedly heating each of the plurality of needles until sweat is induced from the tissue.

2. The method for heat source acupuncture and body shaping of claim 1, wherein the plurality of needles is at least three needles.

3. The method for heat source acupuncture and body shaping of claim 2, further comprising inserting a first needle into 2 inches or 3 inches of tissue, wherein the first needle is placed 1 inch deep.

4. The method for heat source acupuncture and body shaping of claim 3, wherein the first needle is placed at a 45-degree angle.

5. The method for heat source acupuncture and body shaping of claim 2, further comprising inserting a second needle into 3 inches to 5 inches of tissue, wherein the second needle is placed 1.5 inches deep.

6. The method for heat source acupuncture and body shaping of claim 5, wherein the second needle is placed at a 45-degree angle.

7. The method for heat source acupuncture and body shaping of claim 2, further comprising inserting a third needle into a minimal amount of tissue, wherein the third needle is placed 0.25 inches deep.

8. The method for heat source acupuncture and body shaping of claim 7, wherein the third needle is placed at a 45-degree angle.

9. The method for heat source acupuncture and body shaping of claim 1, further comprising heating each of the plurality of needles for at least 3 seconds.

10. The method for heat source acupuncture and body shaping of claim 1, wherein each needle is heated 30 times.

11. The method for heat source acupuncture and body shaping of claim 1, wherein the heat source is an open flame.
